(19) United States
(12) Patent Application Publication
(10) Pub. No.: US 2022/0292172 A1
(43) Pub. Date: Sep. 15, 2022

(54) OFF-DEVICE BIOMETRIC ENROLMENT

(71) Applicant: ZWIPE AS, Oslo (NO)

(72) Inventors: Anthony SIMS, Colorado Springs, CO (US); Alireza Farrokh BAROUGHI, Colorado Springs, CO (US)

(21) Appl. No.: 17/754,161

(22) PCT Filed: Oct. 23, 2020
(86) PCT No.: PCT/EP2020/079853

§ 371 Date: Mar. 25, 2022

Related U.S. Application Data
(60) Provisional application No. 62/927,746, filed on Oct. 30, 2019.

(30) Foreign Application Priority Data
Nov. 29, 2019 (GB) 1917509.0

(51) Int. Cl. G06F 21/32; G06V 40/50; G06V 40/12; G06V 40/13

(52) U.S. Cl. CPC G06F 21/32; G06V 40/50; G06V 40/1359; G06V 40/1353; G06V 40/13

(57) ABSTRACT

A method of enrolling an authorised user onto a biometrically-authorisable device having an on-board fingerprint sensor. The method including capturing a representation of a fingerprint of the authorised user using a fingerprint sensor on an enrolment terminal that is separate from the biometrically-authorisable device, the fingerprint sensor of the enrolment terminal being larger than the fingerprint sensor of the biometrically-authorisable device, generating a number of fingerprint templates from the captured fingerprint representation, wherein each fingerprint template defines an area of the fingerprint corresponding to the size of the fingerprint sensor of the biometrically-authorisable device, and transmitting the fingerprint templates for storage on the biometrically-authorisable device.

The present disclosure relates to a biometrically-authorisable device storing a plurality of reference biometric templates, to a method of enrolling the plurality of reference biometric templates onto such a device, and to a method of authentication of the identity of a bearer of such a device using the plurality of reference biometric templates.

Biometrically-authorisable devices such as smartcards are becoming increasingly more widely used and include, for example access cards, payment cards, identity cards, and so on. Smartcards are electronic cards with the ability to store data and to interact with the user and/or with outside devices, for example via contactless technologies such as NFC. These cards can interact with suitable reader devices to communicate information in order to enable access, to authorise transactions, and so on.

Smartcards with biometric authorisation can interact with the user via one or more biometric sensors, most commonly a fingerprint sensor, in order to enable access to secure features of the smartcard after successful biometric verification of the bearer of the smartcard, for example in order to authorise financial transactions.

Biometric authorisation typically involves the one-to-one comparison of a scanned biometric identifier with one or more stored reference biometric templates. Many biometrically-authorisable devices are capable of storing multiple such reference biometric templates. In such situations, the authorisation is carried out by successively comparing the biometric input image with each of the stored biometric template images, until either a match is identified or all of the biometric reference templates have been evaluated (i.e. tested). Commonly, a claim of identity would be accepted if the input biometric image matches any of the stored templates, and rejected if an input biometric image matches none of the stored templates.

Biometrically-authorisable smartcards are subject to various constraints that give rise to unique challenges. These constraints include the relatively small size of a smartcard, the intermittent availability of power resources, and the limited processing power. For example, in the case of a contactless payment card, the dimensions of the smartcard are limited by ISO standards and such smartcards are commonly dependent on the reader for power, i.e. with no on-board battery. Thus all components of the smartcard must fit into a tightly-packaged form, as well as ideally being flexible and lightweight. Also the power available to the smartcard is limited, and hence so too is the processing power that can be supported within the smartcard.

Viewed from a first aspect, the present invention provides a method of enrolling an authorised user onto a biometrically-authorisable device having an on-board fingerprint sensor, the method comprising: capturing a representation of a fingerprint of the authorised user using a fingerprint sensor on an enrolment device that is separate from the biometrically-authorisable device, the fingerprint sensor of the enrolment device being larger than the fingerprint sensor of the biometrically-authorisable device; generating a plurality of fingerprint templates from the captured fingerprint representation, wherein each fingerprint template defines an area of the fingerprint corresponding to the size of the fingerprint sensor of the biometrically-authorisable device; and transmitting the plurality of fingerprint templates for storage on the biometrically-authorisable device.

By using a separate enrolment device to capture the representation of the fingerprint of an authorised user, and then using the larger fingerprint to generate a plurality of smaller templates that are then stored on the biometrically-authorisable device, the described method avoids the need to use an on board sensor of the biometrically authorisable device to capture templates. Such on-board sensors are typically relatively small due to power constraints and so are unable to capture the entire finger or a large portion thereof. As such, the separate enrolment device can be used to capture the whole finger of an authorised user, or at least a larger portion of it, and then using the larger fingerprint to generate a plurality of smaller templates that are then stored on the biometrically-authorisable device.

Furthermore, an on-board fingerprint sensor of the biometrically-authorisable device may have limited resolution due to the size and processing constraints of the device (e.g. a smartcard), meaning that some details of the fingerprint may not be accurately captured. Consequently, enrolment may require repeated scanning of the finger in different positions to capture the full extent of the fingerprint and to capture sufficient detail to provide a consistent reference. The described method can be used to avoid these problems.

The biometrically-authorisable device may take any form, including but not limited to, a smartcard, a dongle, a wearable device and/or a device for biometrically secured interactions with the “Internet of Things”.

The biometrically-authorisable device may be a smartcard, which may be a laminated smartcard. The smartcard may have a width of about 86 mm and a height of about 54 mm. Optionally, the smartcard may have a thickness of about 0.76 mm, i.e. such that it conforms to typical credit card dimensions. The smartcard 102 may be an ID-1 identification card in accordance with ISO 7810.

The biometrically-authorisable device may be configured to operate as a payment device, for example it may be a laminated payment card with an integral on-board fingerprint sensor.

The biometrically-authorisable device may be configured to authenticate a bearer of the device when a fingerprint captured by the fingerprint sensor of the biometrically-authorisable device matches at least one of the plurality of fingerprint templates.

The fingerprint sensor of the enrolment device and/or the biometrically-authorisable device may be an area fingerprint sensor. The fingerprint sensor of the biometrically-authorisable device may be mounted within the device body so as to be exposed from a surface of the device body. The fingerprint sensor of the biometrically-authorisable device may be and substantially flush with the surface of the device body. The fingerprint sensor of the biometrically-authorisable device may be positioned so as to be convenient for a user of the device to present a finger (e.g. their thumb) to the fingerprint sensor whilst holding the device.

The fingerprint sensor of the biometrically-authorisable device may be smaller than the area of an average finger; for example, a sensor area of the biometric sensor may have a width of less than 15 mm, optionally less than 12 mm, and further optionally less than 10 mm, and may have a length of less than 15 mm, optionally less than 12 mm, and further optionally less than 10 mm.

A sensor area of the fingerprint sensor of the enrolment device may have a width of greater than 10 mm, optionally greater than 12 mm, and further optionally greater than 15 mm, and may have a length of greater than 10 mm, optionally greater than 12 mm, and further optionally greater than 15 mm.

The fingerprint sensor of the enrolment device may have a higher resolution than the fingerprint sensor of the biometrically-authorisable device.

The plurality of fingerprint templates may be generated from only the captured representation of the fingerprint by the enrolment device. For example, by using a large sensor of the separate enrolment device to capture a larger image of the whole finger, only a single captured representation may be required to generate templates covering substantially the entire finger.

The plurality of fingerprint templates may be non-uniformly distributed across the captured fingerprint representation. For example, the distribution of templates to be more concentrated around regions of interest.

The generating of the plurality of fingerprint templates may comprise: identifying at least one region of interest within the representation of the fingerprint, and generating the plurality of fingerprint templates such that the area of interest is captured by a greater number of the fingerprint templates than an area of lesser interest.

The area of interest may comprise at least one of: a distinctive feature of the fingerprint, such as a whorl of the fingerprint; and an area of the fingerprint having a higher likelihood of regions of being captured by the fingerprint sensor of the biometrically-authorisable device than the area of lesser interest, such as the centre of the fingerprint. By focussing on areas of interest such that they are captured by a greater number of the fingerprint templates, the probability of an authorised user being authenticated is increased.

At least two of the plurality of templates may respectively cover areas of the fingerprint that partially overlap one another. By allowing overlapping between templates, the fingerprint templates can provide greater coverage (i.e. coverage by more templates) of areas of the captured fingerprint representation that have greater distinguishing features, as discussed above, and reduce coverage of areas that have fewer distinguishing features or that are obscured. In addition to this, the fingerprint templates can overlap more on areas that are likely to be more frequently scanned by the biometric sensor of the biometrically-authorisable device. For example, the area of interest may be closer to the centre of the captured fingerprint representation than the area of lesser interest. Templates generated in this way are more likely to match with a scan of a user's finger during use of the device.

The plurality of templates may each comprise minutiae data. For example, each fingerprint template may comprise data indicative of a position, orientation and type of a plurality of minutiae present in the respective area of the captured fingerprint representation.

The method may comprise a step of determining a distribution of templates. The distribution of templates may be based on one or more of: the number of required templates and their size, a desired coverage of distinguishing features of the fingerprint image (e.g. loops, whorls, arches and deltas formed by the ridges), and/or the quality of certain portions of the fingerprint image. For example, if a particular region of the fingerprint is obscured due to dirt or damage to the fingerprint sensor of the enrolment device, or a particular region of the fingerprint has scarce distinguishing features, then this region may be either avoided or given less preference for coverage when determining the distribution of the templates.

The method may comprise determining what size templates are required. This may be a pre-set value or may be determined based on the particular biometrically-authorisable device being enrolled, which could be determined based on data entered by the user or by communication between the enrolment terminal and the biometrically-authorisable device.

The method may comprise determining how many templates are required for enrolment. This may be a predetermined number or may be determined based on data entered by the user or by communication between the enrolment terminal and the biometrically-authorisable device. The method may be used to store further fingerprint templates to a biometrically-authorisable device where one or more fingerprint templates are already stored on a biometrically-authorisable device; for example if some previously enrolled templates have been deleted. In this case, the method may involve determining an amount of available memory on the biometrically-authorisable device and determining a number of additional templates that are to be enrolled based on the amount of available memory.

The size of each of the fingerprint templates may correspond to a size of a representation generated by the biometric sensor of the biometrically-authorisable device during authentication.

The method may comprise a step of determining a distribution and/or size of fingerprint templates based on any of the above considerations.

The enrolment device may comprise an enrolment processing unit and a communications interface for communicating biometric data to the biometrically-authorisable device. The enrolment processing unit of the enrolment device may include a secure processing environment. The captured representation of the fingerprint of the authorised user may be processed in the secure environment of the enrolment processing unit. The plurality of fingerprint templates may be generated, in the secure processing environment of the enrolment processing unit. The plurality of fingerprint templates of the authorised user may be then encrypted to produce secure biometric data, and the encrypting may be performed within the secure processing environment of the enrolment processing unit. Transmitting the plurality of fingerprint templates may comprise transmitting the secure biometric data for storage on the biometrically-authorisable device. By carrying out the above steps in this manner, raw biometric data may be processed only inside the secure environment of the enrolment processing unit, making it more difficult for third parties to intercept such data.

The transmission of the plurality of templates to the biometrically-authorisable device may be performed directly from the enrolment device, for example via a contactless communication protocol such as NFC, with the device.

Alternatively, the enrolment device may be remote from the biometrically-authorisable device (for example, at least 1 km away) and the templates may be communicated to the biometrically-authorisable device indirectly. The enrolment device could be located in a secure location, such as a bank branch, in order to reduce the risk of third parties tampering with the terminal or attempting to intercept the raw biometric data (fingerprints) captured by the terminal.

The plurality of templates may be transmitted to a device provider, which may be a biometrically-authorisable device issuing authority such as a financial authority (e.g. a bank), via a network, such as the internet. The biometrically-authorisable device issuer may then store the biometric data on the biometrically-authorisable device, for example when issuing the biometrically-authorisable device to the authorised user. Optionally, the biometrically-authorisable device issuer may store the user's biometric reference data in a secure database, such that a replacement biometrically-authorisable device can be issued if required.

The method may comprise a user entering details into the enrolment device in order to identify the user and/or biometrically-authorisable device. This step may be performed prior to capturing the representation of the fingerprint. Such details may include a username and password, or may include other details sufficient to identify the user, such as a name, data of birth, address, etc., and/or may include details for identifying the biometrically-authorisable device, such as a unique device number or account details. Such details allow the enrolment device to identify which the biometrically-authorisable device the user is being enrolled onto.

The method may comprise requesting a user to present a desired finger to the fingerprint sensor of the enrolment device. The requesting may be performed using a user interface of the enrolment terminal.

Once a fingerprint has been presented to the fingerprint sensor of the enrolment device, the method may capture a representation of the fingerprint and the templates may be generated in any of the ways described above.

The method may comprise determining if a representation of the fingerprint was captured successfully and may comprise indicating to the user whether or not the representation of a fingerprint is suitable (e.g. high enough quality) to generate templates. If the capturing of a representation was unsuccessful, the enrolment device may indicate this to the user and/or may request the user to present a desired finger again.

Viewed from a second aspect, the present invention provides a system for enrolling an authorised user onto a biometrically-authorisable device having an on-board fingerprint sensor, the system comprising: an enrolment device that is separate from the biometrically-authorisable device, the enrolment device comprising a fingerprint sensor for capturing a representation of a fingerprint of the authorised user, and the fingerprint sensor of the enrolment device being larger than the fingerprint sensor of the biometrically-authorisable device, wherein the system is configured to determine a size of the on-board fingerprint sensor of the biometrically-authorisable device and to generate a plurality of fingerprint templates from the captured fingerprint representation based at least in part on the size of the on-board fingerprint sensor of the biometrically-authorisable device, wherein each fingerprint template defines an area of the fingerprint corresponding to the size of the fingerprint sensor of the biometrically-authorisable device, and wherein the system is configured to communicate the plurality of fingerprint templates for storage on the biometrically-authorisable device.

The system may comprise an enrolment processing unit for generating the plurality of fingerprint templates. The system may also comprise a communications interface for communicating the plurality of fingerprint templates to the biometrically-authorisable device.

The enrolment processing unit may include a secure processing environment.

The enrolment device may comprise the enrolment processing unit.

The communicating of the plurality of fingerprint templates to the biometrically-authorisable device may be performed directly from the enrolment processing unit.

The system may comprise a network and the enrolment processing unit may be remote from the biometrically-authorisable device. The enrolment processing unit may be configured to communicate the templates to the biometrically-authorisable device indirectly via the network.

The enrolment processing unit may be located in a secure location.

The fingerprint sensor of the enrolment device may have a higher resolution than the fingerprint sensor of the biometrically-authorisable device.

The plurality of fingerprint templates may be non-uniformly distributed across the captured fingerprint representation.

The enrolment device may comprise a user interface.

The system may be configured to carry out any method according to the first aspect.

Viewed from a third aspect, the present invention provides a method for biometric authentication of the identity of a user, the method comprising: receiving challenge biometric data representing a biometric identifier of the user, sequentially comparing the challenge biometric data to each of a plurality of reference biometric data templates until match criteria are satisfied, the match criteria including that the challenge biometric data is determined to match at least one of the reference biometric data templates, wherein a sequence in which the challenge biometric data is compared to the reference biometric data templates is ordered in descending order based on an estimated likelihood of a match being determined.

This method assumes that the user of the device is likely to present their biometric identifier in a similar way to the sensor each time that the biometrically-authorisable device is used, and therefore templates that have been commonly matched in the past are more likely to match future scans also. By evaluating templates that are more likely to be matched first, the time taken for a match to be found can be reduced.

The estimated likelihood of a match may be determined based on past matches between previously received challenge biometric data and each of the reference biometric data. For example, the estimated likelihood of a match may correspond to a number of times the respective reference biometric data template has previously matched received challenge biometric data.

The biometrically-authorisable device may store a count of how many times previously received challenge biometric data has been matched to each of the reference biometric data templates. In this way, a record of matches for each reference data template can be kept on the device.

The biometric identifier may be a fingerprint of the user. The plurality of reference biometric data templates may be fingerprint templates. Optionally, the plurality of reference biometric data templates may have been captured by a method as described in the first aspect and/or a system as described in the second aspect.

The first time the authorisation method is carried out, the sequence of the reference biometric data templates may be any order, such as a random order or the order in which they were enrolled on the biometrically-authorisable device. Alternatively, an initial sequence for evaluating the reference templates may be determined based on which reference templates are considered to be the most likely to match (e.g. with templates distributed near the centre of the fingerprint earlier in the sequence, or with templates with a greater number of distinguishing features enrolled earlier in the sequence).

Determining a match may comprise determining that a degree of similarity between the challenge biometric data and the respective reference biometric data template meets a predetermined threshold. For example, whether the similarity provides sufficient confidence that the probability of a false positive is below the predetermined threshold.

Optionally, the match criteria may comprise determining that the challenge biometric data matches at least two of the reference biometric data templates.

The comparing of the challenge biometric data to each of a plurality of reference biometric data templates may be performed using minutia comparison.

The plurality of reference biometric data templates may all correspond to a single authorised user and/or at least two of the plurality of reference biometric data templates may correspond to the same biometric identifier of the authorised user. In the case that the reference biometric data templates are fingerprint templates, the reference biometric data templates may all correspond to a single finger of a single authorised user.

The method may further comprise: responsive to the match criteria being satisfied, determining that the user is an authorised user and authorising an action to be performed. Such an action may be a contact or contactless payment.

The sequence in which the stored reference biometric data templates are compared with the challenge biometric data may be based on a number of times each reference biometric data template has been previously matched. For example, the sequence may be determined by ordering the reference biometric data templates starting with the reference biometric data template which has been matched the most frequently, followed by the second most frequently matched reference biometric data template and so on. The sequence may be updated after determining that the match criteria have been satisfied. Alternatively, the sequence may be determined as the challenge biometric data is sequentially compared to each of the plurality of reference biometric data templates.

The method may comprise removing one or more of the reference biometric data templates from the sequence entirely and optionally also from the biometrically-authorisable device. By reducing the number of reference templates to be evaluated, failed authorisations results can be returned more quickly.

After a predetermined number of authentications have been completed (e.g. 1000 authentications) the method may comprise determining whether any of the reference biometric data templates accounts for a proportion of the total number of matches that is less than a predetermined threshold, such as 1%. This determination may be performed periodically (for example, after ever 1000 authentications).

The removal of one or more of the reference biometric data templates from the sequence entirely may be based on this determination. This speeds up the process of obtaining a fully negative result (i.e. no authorisation occurring), as fewer reference biometric data templates have to be evaluated.

The method may be performed by a biometrically-authorisable device having an on-board fingerprint sensor. The challenge biometric data may be received from the fingerprint sensor. The biometrically-authorisable device may comprise a smartcard.

The biometrically-authorisable device may be a batteryless device, which may be powered by energy harvested from an excitation field.

The biometrically-authorisable device may be configured to perform the biometric authentication of the identity of a user within a secure processing environment, i.e. such that the user's biometric data (both the challenge data and the reference data templates) is never transmitted off of the biometrically-authorisable device.

The biometrically-authorisable device may provide an indication of successful and/or unsuccessful authorisation using a suitable indicator, such as an LED.

The biometrically-authorisable device may comprise a fingerprint-processing module for comparing the challenge biometric data to each of the plurality of reference biometric data templates.

The fingerprint-processing module may include a memory, and the memory may be a solid-state, non-volatile memory, such as Flash memory. The memory may store the reference templates described herein.

The biometric authentication of the identity of a user may be performed within two seconds, preferably within one second.

The method for biometric authentication of the identity of a user according to the third aspect may be used with a plurality of fingerprint templates that have been stored on a biometrically-authorisable device according to any of the methods described according to the first aspect and/or any of the systems described according to the second aspect.

Viewed from a fourth aspect, the present invention provides a computer program product or a tangible computer-readable medium storing a computer program product, wherein the computer program product comprises computer-readable instructions that when executed will cause a biometrically-authorisable device to perform any method according to the third aspect.

Viewed from a fifth aspect, the present invention provides a biometrically-authorisable device, comprising: a biometric sensor; and a memory for storing a plurality of reference biometric data templates, wherein the biometrically-authorisable device is configured to perform biometric authentication of the identity of a user by capturing a biometric identifier of the user using the biometric sensor; generating challenge biometric data based on the captured biometric identifier of the user; and sequentially comparing the challenge biometric data to each of a plurality of reference biometric data templates stored in the memory until match criteria are satisfied, the match criteria including that the challenge biometric data is determined to match at least one of the reference biometric data templates, wherein a sequence in which the challenge biometric data is compared to the reference biometric data templates is ordered in descending order based on an estimated likelihood of a match being determined.

The biometrically-authorisable device may further comprise a processor configured to carry out any method according to the third aspect.

The reference biometric data templates stored on the memory of the device may have been stored using any method according to the first aspect and/or any system according to the second aspect.

The estimated likelihood of a match may be determined based on past matches between previous challenge biometric data and each of the reference biometric data templates.

The estimated likelihood of a match may correspond to a number of times the respective reference biometric data template has previously matched challenge biometric data.

The biometrically-authorisable device may be configured to store a count of how many times previous challenge biometric data has been matched to each of the reference biometric data templates stored in the memory of the device.

The estimated likelihood of a match may be determined based on the count of how many times previous challenge biometric data has been matched to each of the reference biometric data templates.

Responsive to the match criteria being satisfied, the biometrically-authorisable device may be configured to determine that the user is an authorised user and authorises an action to be performed.

The biometrically-authorisable device may have an on-board biometric sensor that is a fingerprint sensor and the biometric identifier of the user may be captured by the fingerprint sensor.

The biometrically-authorisable device may comprise a smartcard.

The biometrically-authorisable device may be a batteryless device and may be configured to harvest powered by energy harvested from a radio-frequency excitation field.

The plurality of biometric data templates stored in the memory of the device may all correspond to a single authorised user.

The biometrically-authorisable device may comprise a fingerprint biometric-processing module for comparing the challenge biometric data to each of the plurality of reference biometric data templates. The fingerprint biometric-processing module may comprise a secure processing environment, wherein the biometric authentication of the identity of a user is performed within a secure processing environment of the fingerprint biometric-processing module, and the reference biometric data templates and/or the challenge biometric data may not be transmitted from the secure processing environment.

Certain preferred embodiments of the present invention will now be described in greater detail by way of example only and with reference to the accompanying drawings, in which:

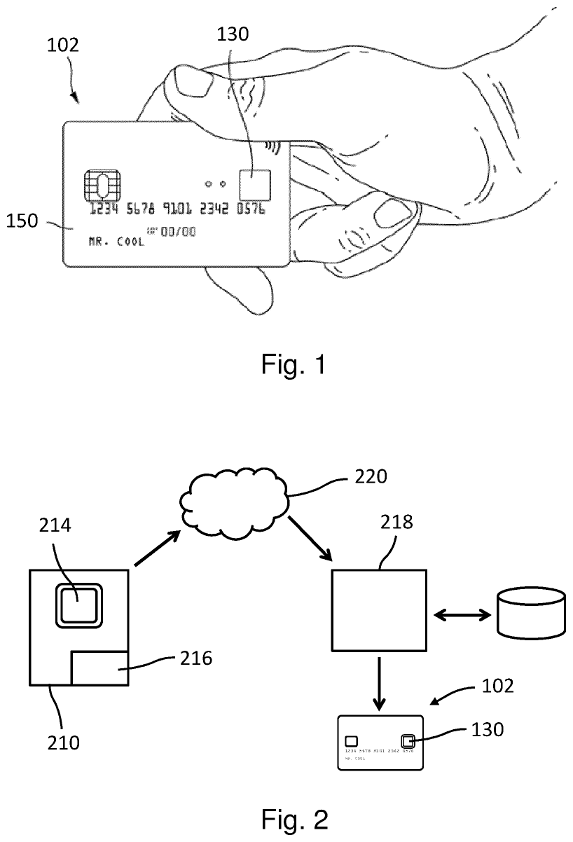

FIG. 1 shows a biometrically-authorisable smartcard;

FIG. 2 shows an off-card enrolment device for enrolling a plurality of biometric templates onto the biometrically-authorisable smartcard;

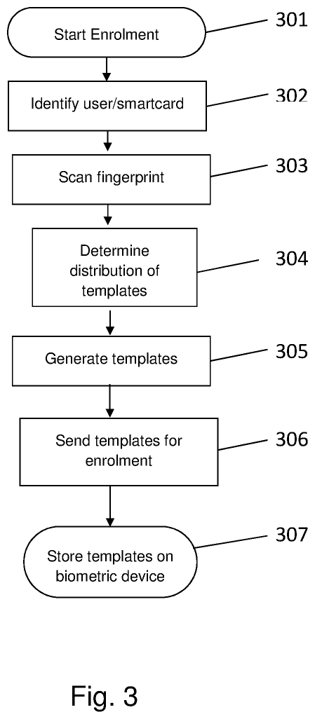

FIG. 3 shows a sequence of steps for performing the enrolment;

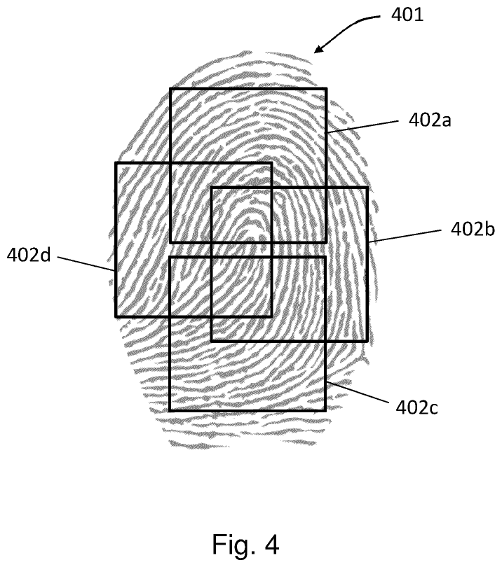

FIG. 4 shows the locations of a plurality of small-frame fingerprint images with reference to a full-frame fingerprint image; and

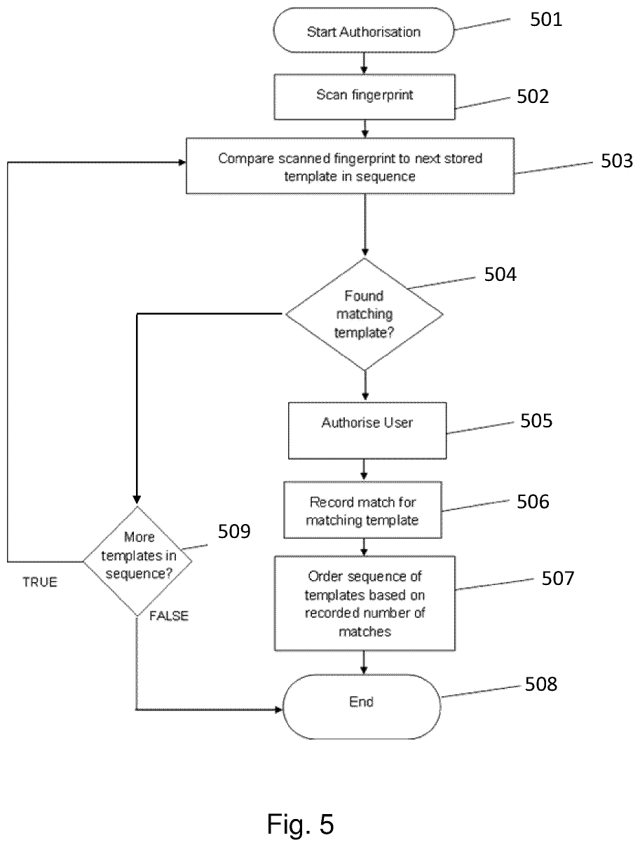

FIG. 5 is a sequence of steps performable by the biometrically-authorisable smartcard for authorisation of a bearer of the smartcard.

The following embodiments are described with reference to fingerprint-authorisable smartcards. However, the techniques described are applicable to biometrically-authorisable devices taking any form, such as a dongle, a wearable device and/or a device for biometrically secured interactions with the “Internet of Things”.

A fingerprint-authorisable smartcard 102 configured to operate as a payment card will be first described with reference to FIG. 1.

The smartcard 102 comprises a laminated card body 150 incorporating an integral, on-board fingerprint sensor 130. An exemplary technique for manufacturing such a card body 150 is described in WO 2013/160011. The card body 150 preferably has a width of about 86 mm, a height of about 54 mm and a thickness of about 0.76 mm, i.e. such that it conforms to typical credit card dimensions, although in some embodiments the thickness may be increased to accommodate the fingerprint sensor 130. More generally the smartcard 102 may be an ID-1 identification card in accordance with ISO 7810.

The fingerprint sensor 130 is an area fingerprint sensor 130, and is mounted within the card body 150 so as to be exposed from and substantially flush with a surface of the card body 150. The fingerprint sensor 130 is positioned so as to be convenient for a user of the card to present a finger (commonly their thumb) to the fingerprint sensor 130 whilst holding the smartcard 102. Due to power and size constrains, the fingerprint sensor 130 is typically smaller than an average finger, for example with a sensor area of less than 10 mm×10 mm.

Full access to the secure features of the smartcard 102 (e.g. payment functions) requires biometric authorisation, i.e. verification of the identity of the user by matching a presented biometric identifier to stored reference biometric data templates. The process for biometric authorisation will be discussed later in greater detail.

The smartcard 102 is configured to perform the biometric authorisation locally, preferably within a secure processing environment of the smartcard 102, i.e. such that the user's biometric data (both the scanned data and the reference data templates) is never transmitted off of the smartcard 102. The smartcard 102 may provide an indication of successful authorisation using a suitable indicator, such as a first LED 136.

The card body 150 houses a fingerprint-processing module for providing biometric authorisation by verification of the identity of the user of the smartcard 102 based on a fingerprint captured by the fingerprint sensor 130.

The fingerprint-processing module includes a memory storing one or more reference fingerprint templates. The memory of the smartcard 20 is commonly a solid-state, non-volatile memory, such as Flash memory. The fingerprint templates are generated and stored in the memory of the fingerprint-processing module by an enrolment process, which will be discussed later in greater detail.

The fingerprint-processing module is arranged to receive scanned fingerprint data representing a finger or thumb presented to the fingerprint sensor 130 and to compare the scanned fingerprint data to pre-stored, reference fingerprint data, which may comprise a plurality of reference fingerprint templates. A determination is then made as to whether the scanned fingerprint matches the reference fingerprint data. It is desirable for the smartcard 102 to be able to complete the process of capturing a fingerprint image via the fingerprint sensor 130 and authenticating the user via the fingerprint-processing module of the smartcard 102 within about one second.

If a match is determined between the scanned fingerprint and the reference fingerprint data, then the fingerprint-processing module takes appropriate action depending on its programming. In this example, if there is a match with the reference fingerprint data, then the fingerprint-processing module provides authorisation data to the secure element within the smartcard 102 to authorise a payment. In some embodiments, it is envisaged that the fingerprint-processing module may be a virtual module incorporated within the secure element of the smartcard 102.

The smartcard 102 includes a wireless communications interface comprising a tuned circuit that is tuned to receive an RF signal from the card reader, for example using near field communication (NFC) in the case of the illustrated payment smartcard 102. The tuned circuit typically comprises an antenna coil and passive electro-magnetic components or passive circuit card parasitic properties.

The smartcard 102 may communicate with a card reader via the wireless communications interface, for example to transmit the payment authorisation in the example above. The wireless communications interface transmits data using components, such as a transistor, that are connected across the antenna coil. By controlling the transistor, a modulated signal can be transmitted by the smartcard 102 and decoded by suitable control circuits within the card reader. This type of signalling is known as backscatter modulation and is characterised by the fact that the reader is used to power the return message to itself.

The wireless communications interface is further configured to harvest energy when the smartcard 102 is exposed to a radio-frequency excitation field, such as that generated by the card reader, in order to power the components of the smartcard 102, for example including the fingerprint sensor 130, the fingerprint-processing module and the secure element. In this embodiment, the smartcard 102 is “batteryless”, which means that it does not include a battery. Consequently, the components of the smartcard 102 are powered only by the energy harvested from the excitation field.

It should be noted that in alternative embodiments battery-powered smartcards may be provided that have the same features as described. In this alternative embodiment, the smartcard 102 may have the same structure and provide the same functionality, and the only difference is that the use of harvested power may be replaced by the power from a battery that is contained within the card body 150.

The fingerprint enrolment process will now be described in more detail with reference to FIGS. 2 to 4.

In some embodiments, the smartcard 102 may be configured such that an authorised user can enroll their biometric data directly onto the smartcard 102 using the on-board fingerprint sensor 130 of the smartcard 102. However, this is not always desirable. This is because, commonly, the on-board fingerprint sensor 130 is relatively small due to power constraints and so is unable to capture the entire finger. Furthermore, the fingerprint sensor 130 may have limited resolution due to the size and processing constraints of the smartcard 102, meaning that some details may not be well captured. Consequently, enrolment may require repeated scanning of the finger in different positions to capture the full extent of the finger and to capture sufficient detail to provide a consistent reference template for comparison.

The following enrolment process proposed a solution to this problem by using a separate enrolment system to capture the whole finger, or at least a larger portion of it, and then generate a plurality of smaller templates from the full fingerprint image that are then stored on the smartcard 102. As discussed above, the smartcard 102 is able to use a plurality of template images, which are evaluated in series, to determine whether a user of the smartcard 102 is the authorised user of the smartcard 102.

FIG. 2 shows an enrolment system 200 that can be used for biometric enrolment of a user onto the smartcard 102. It will be appreciated that a similar enrolment system 200 may be used for biometric enrolment of a user onto other biometrically-authorisable devices.

The enrolment system 200 comprises an enrolment terminal 210 having a fingerprint sensor 214, which is a fingerprint sensor 214 having a larger sensor area than the fingerprint sensor 130 of the smartcard 102, and preferably one sufficiently large that it can capture the entire finger of the user. In some embodiments, the fingerprint sensor 214 of the enrolment terminal 210 may also have a higher resolution than the fingerprint sensor 130 of the smartcard 102

The enrolment terminal 210 further comprises an enrolment processing unit 216 and a communications interface for communicating biometric data to the smartcard 102. The communication of the biometric data to the smartcard 102 may be performed directly from the enrolment terminal 210, for example via a contactless communication protocol such as NFC, with the smartcard 102. However, in the present embodiment, the enrolment terminal 210 is remote from the smartcard 102 and the biometric data is communicated to the smartcard 102 indirectly. The enrolment terminal could be located in a secure location, such as a bank branch, in order to reduce the risk of third parties tampering with the terminal or attempting to intercept the raw biometric data captured by the terminal.

In this embodiment, the biometric data is transmitted to a smartcard provider 218, which may be a smartcard issuing authority such as a financial authority (e.g. a bank), via a network 220, such as the internet. The smartcard issuer 218 will then store the biometric data on the smartcard 102, for example when issuing the smartcard 102 to the authorised user. Optionally, the smartcard issuer 102 may store the user's biometric reference data in a secure database, such that a replacement smartcard can be issued if required.

The enrolment system 200 could operate as a black box system, such as described in GB 2556625 in order to securely enroll biometric data on the smartcard 102.

The enrolment processing unit 216 of the enrolment terminal 210 includes a secure processing environment, where the biometric data is processed in the secure processing environment of the enrolment processing unit 216. The biometric data is then encrypted to produce secure biometric data, with the encrypting still being performed within the secure processing environment of the enrolment processing unit 216. Only once the data is encrypted, is the secure biometric data transmitted either to the smartcard 102 or to the smartcard provider 218. The smartcard provider then loads the biometric data onto smartcard 102 before issuing the smartcard to the user.

FIG. 3 shows an enrolment method that is performed by the biometric enrolment terminal 210.

The enrolment process begins at step 301.

Where the enrolment terminal 210 is remote from the smartcard 102 that is being enrolled, the initiation of the enrolment process may comprise the user entering identifying details into the enrolment system 200 at step 302 where the user and/or smartcard are identified. Such details may include a username and password, or may include other details sufficient to identify the user, such as a name, data of birth, address, etc., or may include details for identifying the smartcard 102, such as a unique card number or account details associated with the smartcard 102. Such details allow the enrolment system 200 to identify which smartcard 102 the user is being enrolled onto.

Next, at step 303, the enrolment terminal 210 requests the user to present a desired finger to the fingerprint sensor 214. The enrolment terminal 210 detects that a finger has been presented to the fingerprint sensor 214 and the detected finger is scanned by the fingerprint sensor 214 to produce a single fingerprint image. This fingerprint image may cover the entire fingerprint, or only a portion.

This step may also comprise determining if the fingerprint scan was successful. For example, it may comprise assessing how much of the fingerprint has been captured and determining whether the portion of the fingerprint that has been captured is sufficient for enrolment of the user to be performed. Alternatively, or in addition, it may comprise assessing whether the fingerprint scanned image is of a high enough quality for enrolment to be carried out.

If necessary, the enrolment terminal 210 may repeat step 303 until a suitable fingerprint image is captured.

Once the fingerprint image has been successfully captured by the fingerprint sensor 214, the method proceeds to step 304, wherein a distribution of a plurality of templates in relation to the fingerprint image is determined. The optimum distribution may be based on one or more of: the number of required templates and their size, optimum coverage of distinguishing features of the fingerprint image (e.g. bifurcations, loops, whorls, arches and deltas formed by the ridges), and/or the quality of certain portions of the fingerprint image. For example, if a particular region of the fingerprint is obscured due to dirt or damage to the sensor 214, or a particular region has scarce distinguishing features, then this region may be either avoided or given less preference for coverage when determining the distribution of the templates.

Step 304 may comprise determining what size templates are required for processing on the smartcard 102. This may be a pre-set value or may be determined based on the particular smartcard 102 being enrolled, which could be determined based on the data entered by the user.

Step 304 may also comprise determining how many templates are required for enrolment. Typically this will be a predetermined number, for example in one embodiment 32 templates may be stored during an initial enrolment process of a new card. However, the enrolment process could also be used to lop up′ the templates stored on the smartcard 102, for example if some previously enrolled templates have been deleted. In this case, step 304 may involve determining the amount of available memory on the smartcard 102 and the number of additional templates that are to be enrolled.

An example distribution of templates 402 in relation to a fingerprint image 401 that has been captured by the biometric sensor 214 of the enrolment terminal 210 is shown in FIG. 4. Whilst only four templates are shown in FIG. 4 it will be appreciated that in practice more templates may be distributed to provide a more complete distribution across the fingerprint image as required. The distribution of the templates can be such that a greater number of templates cover areas that are expected to be more frequently scanned by the biometric sensor of the card (e.g. the centre of the user's fingerprint typically is the area that is captured by this sensor; thus, more overlap between templates would be found in the centre of the image and less towards the edges). By tailoring the distribution of templates in this way, the likelihood of finding a match between one of the templates and the portion of a user's fingerprint captured by the smartcard 102 during an authorisation can be increased.

Each of the templates covers the same sized area, as this size is determined based on the authorisation algorithm and/or sensor employed in the smartcard 102. Commonly, the algorithm is designed for use with a template covering an area approximately equal to the area of the fingerprint image captured by the fingerprint sensor 130 of the smartcard 102.

Turning back to method shown in FIG. 3, once the optimum distribution of templates has been determined, the templates are generated at step 305 and sent to a smartcard provider 218 at step 306 before being enrolled by the smartcard provider 218 on the smartcard at step 307.

Step 306 comprises transmitting the templates, preferably in encrypted form as secure biometric data, from the enrolment processing unit to a smartcard provider 218, such as a financial authority (e.g. a bank) that issues smartcards 102. At step 307, the biometric templates loaded onto the smartcard 102 by the financial authority before the smartcard 102 is issued to the user.

Alternatively, as discussed above, step 306 may comprise transmitting the biometric templates directly from the enrolment terminal 210 to the smartcard 102.

A fingerprint matching process for determining whether the bearer of the smartcard 102 is the enrolled user will now be described in more detail with reference to FIG. 5.

The following described fingerprint matching process is particularly advantageous when employed in combination with the enrolment technique discussed above with reference to FIGS. 2 to 4. However, it may also be employed in combination with biometric authentication devices where a plurality of reference biometric templates have been captured or generated in another manner, such as by repeatedly presenting a fingerprint to the fingerprint sensor 130 of the smartcard.

As discussed above, the smartcard 102 is arranged to scan a finger or thumb presented to the fingerprint sensor 130 and to compare the scanned fingerprint of the finger or thumb to stored fingerprint data comprising a plurality of reference fingerprint templates, for example the plurality of reference fingerprint templates that were generated during the enrolment process discussed above.

The fingerprint authentication engine of the smartcard 102 compares the scanned fingerprint to each of the stored templates in sequence. However, the smartcard 102 has limited processing power, and so the evaluating of a larger number of templates can become very time consuming. In the worst-case scenario, where particular scan only matches the last template in the evaluation sequence, the evaluation can take well over a second to complete.

It has been identified that the average time required to perform a match can be reduced by dynamically changing the sequence in which the templates are compared to the scanned fingerprint, based on statistical analysis of past use of the smartcard 102. The technique for doing this will be described in more detail below.

In general terms, each time a fingerprint match is determined, a counter associated with the template that matched with the scanned fingerprint is incremented. Then when performing subsequent authorisations, the sequence of templates used for evaluating a respective scanned fingerprint is determined based on the counter values for the templates. That is to say, the authentication process starts with comparison of the scanned fingerprint against the template having the highest counter value, and the scanned fingerprint is then sequentially evaluated against the templates in descending counter value order, until either a match is determined or all templates have been evaluated.

This technique works on the presumption that the user of the smartcard 102 is likely to present their finger to the smartcard 102 in a substantially consistent manner. This means that some templates (for example a template at the centre of the finger) are more likely than others templates (for example a template at the edge of the finger of a template where the scan was of poor quality) to be matched. Thus, the processing time for completion of a successfully authorisation can be, on average, minimised by evaluating a scanned fingerprint against the templates that have been most frequently matched in the past.

This optimisation is carried out throughout the lifetime of the smartcard 102.

A method of authorisation of the smartcard 102 will now be described in relation to FIG. 5.

The authorisation begins at step 501 when the smartcard 102 detects that a finger has been presented to the fingerprint sensor 130.

Next, at step 502, the fingerprint sensor 130 proceeds to scan the fingerprint that is present to produce a digital copy of the fingerprint. The digital fingerprint is converted to a challenge template.

At step 503, the challenge template is compared to each reference template in a sequence based on the matched occurrence of templates. The card is initially enrolled with a number of reference templates that each represent a portion of the authorised user's fingerprint. In one particular embodiment, 32 reference templates are stored on the smartcard 102 during enrolment, but any number of reference templates may be used.

The first time the authorisation method is carried out, the sequence of the reference templates may be any order, such as a random order or the order in which they were enrolled on the card. In some embodiments, a sequence for evaluating the reference templates may have been determined based on which reference templates are considered to be the most likely to match (e.g. with templates distributed near the centre of the fingerprint earlier in the sequence, or with templates with a greater number of distinguishing features enrolled earlier in the sequence).

After comparing the challenge template to this reference template, it is determined at decision step 504 whether or not the challenge template matches the reference template of the authorised user.

A match is determined between the challenge template and the reference template when the degree of similarity between the two provides sufficient confidence that the probability of a false positive is below a predetermined threshold.

The matching is preferably carried out using minutia comparison, and WO 2014/068089 describes a method of matching a reference fingerprint image to a challenge fingerprint image represented by a first set of minutiae and a second set of minutiae respectively. It will be appreciated that any suitable comparison method may be utilised.

If, at decision step 504, it is determined that the challenge template does not match the reference template to which it has been compared, the method proceeds to step 509 where it is determined whether there are more unevaluated reference templates left in the sequence. If all the reference templates have been evaluated and no matches found, then the method ends at step 508 with no authorisation occurring. If there are more reference templates on the card that have not been evaluated, the method returns to step 503 and evaluates the next template in the sequence.

If it is determined that the challenge template matches the reference template to which it has been compared, the method proceeds to step 505, and the user is authorised. The smartcard 102 then takes suitable action as discussed above, for example authorising the use of the smartcard 104. Authorising the use of the smartcard includes activating secure aspects of the smartcard 102 such as authorising one or more payments to be made.

The authorisation occurs immediately after a match is determined such that the challenge template is not compared against any more reference templates in order to minimise the time required for authorising use of the card. However, in alternative embodiments, additional criteria may be required to be met before determining a match and/or authorising the user.

Once the user has been authorised, the method proceeds to step 506, where it is recorded that a match has been found with the reference template that was compared and matched to the challenge template.

In this way, a record of the number of times each reference templates has matched a challenge template is stored on the card. Each time a fingerprint match is determined, a stored match counter for the reference template is incremented. A record of the number of times each reference template is matched is therefore stored on the smartcard 102 and updated with each authorisation. This record can be maintained for the entire lifetime of the smartcard 102. Optionally, the sum of all matches may also be recorded separately.

The method then proceeds to step 507, where the fingerprint-processing module analyses the record of the number of matches for each reference template and determines whether or not to modify the sequence in which the templates are to be evaluated.

The sequence in which the stored reference templates are compared with a challenge template may be based on the record of the number of times each reference template has been matched by ordering the sequence starting with the reference template which has been matched the most, followed by the second most matched reference template and so on. If one or more reference templates have the same number of matches, the most recently matched reference template may take priority. By evaluating the most commonly matched reference templates first, a match is more likely to be found in a shorter period of time.

Alternatively, step 507 may be omitted and the sequence could be determined as the authorisation method is performed. For example, step 503 may include selecting the reference template with the next most recorded matches for comparison. This avoids the need for a list of reference templates to be repeatedly reordered.

If the total number of recorded matches for any one reference template exceeds a predetermined number, the processor can reset the records of recorded matches without altering the sequence of the reference templates. For example, if there were 32 stored reference templates, the most commonly matched reference template had 255 recorded matches and this was the maximum predetermined number of matches, the processor could reset the number of recorded matches associated with this reference template to 31. The second most commonly matched reference template could be reset to 30, the third to 29 and so on, down to the least matched reference template which would be reset to 0. In this way, the sequence is not altered but constraints placed on the stored data can always be met. For example, if a single byte is used to store the number of matches, the maximum total number of recorded matches will be 255.

Alternatively, if the total number of recorded matches for any one reference template exceeds a predetermined number (e.g. 255), its position in the sequence may be set. For example, once the most commonly matched template has 255 recorded matches it may be set as the first template in the sequence, and no more reordering of this reference template may occur (i.e. it will remain the first in the sequence). The algorithm can then continue recording matches against the remaining templates that have less than then the predetermined number of recorded matches until the next one of the remaining reference templates exceeds the predetermined number of matches and is set in the same manner as above, but as the second template in the sequence. Such a method can be carried out until all of the templates have the maximum number of recorded matches and the sequence is set. It will also be appreciated that each template may have a different maximum number of recorded matches depending on its position in the series. For example, the most commonly matched template may be set once it has 255 matches, the second most commonly matched template may be set once it has 254 matches and so on. In this way, the order of the series is maintained.

Once the fingerprint-processing module determines that the sequence of the reference templates is in the correct order, the user authorisation process ends at step 508, and the fingerprint-processing module is placed in a state where it is ready to be initiated again.

Optionally, the fingerprint-processing module may remove one or more of the reference templates from the sequence entirely. By reducing the number of reference templates to be evaluated, failed authorisations results can be returned more quickly.

In one example, it may be determined after a certain number of verifications have been completed (for example after 1000 verifications) whether any of the reference templates account for a proportion of the total number of matches that is less than a predetermined threshold, such as 1%. Optionally, this evaluation may be performed periodically (for example, after ever 1000 verifications).

These reference templates can thus be removed from the evaluating sequence, for example by deletion.

Reference biometric templates with a low proportion of matches are those that are less useful to the matching algorithm. For example, they may have poor quality and so do not match well, or they may be so dissimilar to the way in which the user typically presents their fingerprint to the fingerprint sensor 130 that they are very unlikely to match an input fingerprint image, or they are so similar to another stored reference template that is higher in the sequence.

It will be noted that the above described deletion step of reference templates with a low proportion of matches speeds up the process of obtaining a fully negative result (i.e. no authorisation occurring), as fewer reference templates have to be evaluated. In this way, a second authorisation attempt with a new scanned fingerprint can be attempted sooner; thus reducing the overall wait time for the user.

Furthermore, a determination of an imposter user fingerprint (or an incorrect fingerprint of a genuine user) can be made quicker, because any such imposter user fingerprint will have to be compared with fewer reference templates. Therefore, as mentioned above, the overall time for a fully negative result (and the determination that the challenge fingerprint is that of an imposter user or a wrong finger of a genuine user) will be shorter.

By deleting such reference templates, the time required for the authorisation process can be reduced as time is no longer spent evaluating templates that are unlikely to match.

We claim:

1. A method of enrolling an authorised user onto a biometrically-authorisable device having an on-board fingerprint sensor, the method comprising:
capturing a representation of a fingerprint of the authorised user using a fingerprint sensor on an enrolment terminal that is separate from the biometrically-authorisable device, the fingerprint sensor of the enrolment terminal being larger than the fingerprint sensor of the biometrically-authorisable device;
generating a plurality of fingerprint templates from the captured fingerprint representation, wherein each fingerprint template defines an area of the fingerprint corresponding to the size of the fingerprint sensor of the biometrically-authorisable device; and
transmitting the plurality of fingerprint templates for storage on the biometrically-authorisable device.

2. A method according to claim 1, wherein the biometrically-authorisable device is configured to authenticate a bearer of the device when a fingerprint captured by the fingerprint sensor of the biometrically-authorisable device matches at least one of the plurality of fingerprint templates.

3. A method according to claim 1, wherein the plurality of fingerprint templates is generated from only the captured representation.

4. A method according to claim 1, wherein at least two of the plurality of templates respectively cover areas of the fingerprint that partially overlap one another.

5. A method according to claim 1, wherein the plurality of fingerprint templates are non-uniformly distributed across the captured fingerprint representation.

6. A method according to claim 1, wherein generating the plurality of fingerprint templates comprises:
identifying at least one region of interest within the representation of the fingerprint, and
generating the plurality of fingerprint templates such that the area of interest is captured by a greater number of the fingerprint templates than an area of lesser interest.

7. A method according to claim 6, wherein the area of interest comprises at least one of:
a distinctive features of the fingerprint, such as a whorl of the fingerprint; and
an area of the fingerprint having a higher likelihood of regions of being captured by the fingerprint sensor of the biometrically-authorisable device than the area of lesser interest, such as the centre of the fingerprint.

8. A method according to claim 1, wherein the plurality of fingerprint templates each comprise minutiae data.

9. A method according to claim 1, wherein the plurality of fingerprint templates is transmitted from the enrolment terminal to the biometrically-authorisable device via a wide-area network, and preferably via the internet.

10. A method according to claim 9, wherein the plurality of fingerprint templates is transmitted from the enrolment terminal to a device provider, and wherein the device provider stores the plurality of fingerprint templates on the biometrically-authorisable device prior to issuing the biometrically-authorisable device to the user.

11. A method according to claim 1, wherein the plurality of fingerprint templates is transmitted directly from the enrolment terminal to the biometrically-authorisable device.

12. A method according to claim 1, wherein the plurality of fingerprint templates is transmitted from the enrolment terminal to the biometrically-authorisable device in encrypted form, and wherein a decryption key to decrypt the plurality of fingerprint templates is stored on the biometrically-authorisable device.

13. A system for enrolling an authorised user onto a biometrically-authorisable device having an on-board fingerprint sensor, the system comprising:
an enrolment terminal that is separate from the biometrically-authorisable device, the enrolment terminal comprising a fingerprint sensor for capturing a representation of a fingerprint of the authorised user, and the fingerprint sensor of the enrolment terminal being larger than the fingerprint sensor of the biometrically-authorisable device,
wherein the system is configured to determine a size of the on-board fingerprint sensor of the biometrically-authorisable device and to generate a plurality of fingerprint templates from the captured fingerprint representation based at least in part on the size of the on-board fingerprint sensor of the biometrically-authorisable device, wherein each fingerprint template defines an area of the fingerprint corresponding to the size of the fingerprint sensor of the biometrically-authorisable device, and wherein the system is configured to communicate the plurality of fingerprint templates for storage on the biometrically-authorisable device.

14. A system according to claim 13, wherein the system comprises an enrolment processing unit for generating the plurality of fingerprint templates and a communications interface for communicating the plurality of fingerprint templates to the biometrically-authorisable device, wherein the enrolment processing unit preferably includes a secure processing environment.

15. A system according to claim 14, wherein the communicating of the plurality of fingerprint templates to the biometrically-authorisable device is performed directly from the enrolment processing unit.

16. A system according to claim 14, wherein the enrolment processing unit is configured to operate remotely from the biometrically-authorisable device, the enrolment processing unit is configured to communicate the templates to the biometrically-authorisable device indirectly via a network, and wherein the enrolment processing unit is preferably located in a secure location.

17. A system according to claim 13, wherein the fingerprint sensor of the enrolment terminal has a higher resolution than the fingerprint sensor of the biometrically-authorisable device.

18. A system according to claim 13, wherein system is configured to generate the plurality of fingerprint templates such that they are non-uniformly distributed across the captured fingerprint representation.
